(19) United States
(12) Patent Application Publication
(10) Pub. No.: US 2016/0293049 A1
(43) Pub. Date: Oct. 6, 2016

(54) DRIVING TRAINING AND ASSESSMENT SYSTEM AND METHOD

(71) Applicants: Jay Monahan, Williston, VT (US); Miriam Monahan, Williston, VT (US); Anthony D. Pagani, Montpelier, VT (US)

(72) Inventors: Jay Monahan, Williston, VT (US); Miriam Monahan, Williston, VT (US); Anthony D. Pagani, Montpelier, VT (US)

(73) Assignee: Hotpaths, Inc., Williston, VT (US)

(21) Appl. No.: 15/078,599

(22) Filed: Mar. 23, 2016

Related U.S. Application Data
(60) Provisional application No. 62/141,625, filed on Apr. 1, 2015.

(51) Int. Cl. G09B 19/16; G06F 3/0484; G06F 3/0482; H04N 5/92

(52) U.S. Cl. CPC G09B 19/167; H04N 5/9201; G06F 3/04842; G06F 3/0482

(57) ABSTRACT

The present disclosure can allow existing and aspiring drivers to be exposed to a plurality of salient driving items, i.e., objects or activities that may require cognitive awareness from the driver, so as to keep these items from becoming a hazard, e.g., something that has the potential of causing vehicle collision/damage, property damage, or personal injury. The user is repetitively and, in some embodiments, simultaneously, exposed to salient items and other non-salient items (i.e., objects or activities that do not require cognitive awareness but are in the driver's field-of-view) in a virtual environment, facilitating the inducement of a recognition response when these same salient items are encountered while driving a vehicle. In certain embodiments, the user can be scored based upon the user's ability to recognize the salient items in a timely manner and in an appropriate sequence.

### RELATED APPLICATION DATA

This application claims the benefit of priority of U.S. Provisional Application No. 62/141,625, filed Apr. 1, 2015 and titled “Driving Training System and Method”, which is incorporated by reference herein in its entirety.

### FIELD OF THE INVENTION

The present invention generally relates to training and assessment systems and methods for improving safe operation of motorized vehicles. In particular, the present invention is directed to a driving training system and method for improving driver recognition and assessment of salient items on the roadway and objectively assessing the ability of a driver to perform critical driving tasks.

### BACKGROUND

Automobile crashes are the number one cause of accidental death worldwide, with nearly 1.3 million people killed each year. The World Health Organization forecasts this number to rise 65% in the next decade. Recognition error, or not seeing salient information on the roadway because of internal or external distractions, accounts for more than 40% of these crashes. This is more than driving under the influence of alcohol or drugs (24%) or speeding (15%). To date, there have been no effective tools available to reduce recognition error crashes.

Various techniques, systems, and methods are available for providing driver education and training, and various processes, systems, and methods are available for driver search and awareness training. Moreover, while many driver training systems and methods employ actual, behind the wheel driver training as at least one component, there are also driving simulators in which images are displayed on a display device and a steering wheel, brake, and accelerator are typically connected in a feedback loop and, under computer control, the image displayed varies as a function of the driver's operation of those components. Additional views, such as left side views, right side views, and rear views may be provided within separate windows on the display device, or using separate display devices for views in addition to views simulating a forward view. While existing systems and methods are useful for teaching the rules of the road and mechanics of driving, little has been done to develop and enhance the cognition skills required of drivers for the act of driving.

Driving safely is important for all vehicle operators, but is often difficult for new drivers, senior drivers, and drivers experiencing a loss of, or impairment in, their driving skills. In addition, drivers that are unfamiliar with the native language and/or the written and unwritten rules of driving where they are operating a vehicle may find it difficult to drive safely. The results of unsafe driving have serious consequences. It has been reported that elderly people, new drivers, drivers unfamiliar with a new area, and veterans returning from overseas deployment have high rates of fatal crashes per miles driven. A common theme around these crashes is the driver not recognizing salient items and/or not filtering out non-salient items. As a result, the driver is looking at the wrong thing at the wrong time.

Young or otherwise cognitively impaired drivers, e.g., drivers suffering from afflictions such as PTSD, Attention Deficit Hyperactivity Disorder, or Autism Spectrum Disorder also have issues recognizing and filtering out the various salient and non-salient items encountered on the roadway and adapting their driving to safely navigate these potential hazards.

Moreover, even people with excellent driving skills and no recognizable impairment will have difficulties in foreign environs—whether that foreign environment is a foreign country or just an unknown city. Thus, the ability to recognize salient items and to appropriately adapt to prevent these items from becoming hazards has applicability across all populations.

However, notwithstanding training and education opportunities, over the years there have been no significant advances in the ability to assess and improve the driving abilities of new and existing drivers. Likewise, there are no simple-to-use assessment systems with high fidelity and face validity (i.e., the relevance of a test as it appears to test participants).

### SUMMARY OF THE DISCLOSURE

In a first exemplary aspect, a driving training system is disclosed, the driving training system comprising: a media database including a video file, the video file include a plurality of salient items; a computing device in electronic communication with the video file, the computing device including a processor, the processor including a set of instructions for: identifying ones of the a plurality of salient items; developing a hotpath data feed for each of the ones; and merging the hotpath data feed for each of the ones with the video file so as to create a synchronized merge file.

In another exemplary aspect, a method of improving the ability of a user to recognize salient objects while driving a vehicle is disclosed, the method comprising: providing a driving training system that includes a merge file, the merge file including a video file and a hotpath data feed, the hotpath data feed being associated with a plurality of salient items; receiving, from the user, information; developing a user profile from the receiving; displaying at least one merge file to the user based upon the user profile; allowing the user to select one of the at least one merge file; and evaluating the user's interactions with the selected one.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic representation of an information system for use with a driver training and assessment system (DTAS) according to an embodiment of the present invention;

FIG. 2 is a block diagram of a DTAS according to an embodiment of the present invention;

FIG. 3 is an illustration of a DTAS in use according to an embodiment of the present invention;

FIG. 4 is a video frame of a DTAS in use according to an embodiment of the present invention;

FIG. 5 is an illustration of a reporting screen of a DTAS according to an embodiment of the present invention;

FIG. 6 is a block diagram of a hotpath generator according to an embodiment of the present invention;

FIG. 7 is a block diagram of a hotpath generator according to another embodiment of the present invention;

FIG. 8 is block diagram of an exemplary driving training method according to an embodiment of the present invention;

FIG. 9 is a block diagram of an exemplary driver training analysis process according to an embodiment of the present invention; and

FIG. 10 is a schematic representation of a computer system suitable for use with a DTAS according to an embodiment of the present invention.

### DESCRIPTION OF THE DISCLOSURE

A driving training and assessment system (DTAS) and method according to the present disclosure enables existing and aspiring drivers to be exposed to a plurality of salient driving items, i.e., objects or activities that may require cognitive awareness from the driver, so as to keep these items from becoming a hazard, e.g., something that has the potential of causing vehicle collision/damage, property damage, or personal injury. In certain embodiments the DTAS repetitively and, in some embodiments, simultaneously, exposes a user to the salient items and other non-salient items (i.e., objects or activities that do not require cognitive awareness but are in the driver's field-of-view) in a virtual environment, facilitating the inducement of a recognition response when these same salient items are encountered while driving a vehicle. In certain embodiments, the user can be scored based upon the user's ability to recognize the salient items in a timely manner and in an appropriate sequence. The challenge experienced by the user of a DTAS as disclosed herein can be influenced by the speed of the drive, the number of non-salient items employed in addition to the salient items, and the use of additional distractions (loud noises, blinking lights, etc.). To make the repetitive exposure desirable and enjoyable, a DTAS according to the present disclosure can have a game-like interface, including high definition video of a drive that is overlaid with a tactile interface so as to allow the user to indicate recognition of the salient items when the salient items appear in the video.

A DTAS according to the present disclosure can also employ game thinking, game mechanics, and reward systems such as goals, rules, challenges, points and badges, and social interaction to engage and motivate the user into using the DTAS on repeated occasions. This gamification leverages people's natural desires for socializing, learning, mastery, competition, achievement, status, self-expression, altruism, and closure. In certain embodiments, eleven types of objects are used as salient items. As used herein, salient items generally consist of the items that should preferably be recognized and evoke a response to prevent the salient items from becoming hazards. As generally recognized in the literature, hazards are the precursors to crashes. By extension, salient items can be considered precursors to hazards.

Likewise, by monitoring user interaction and scoring the user's ability, the DTAS system can provide an objective assessment of the user's ability to drive a vehicle. This may be important for personal information, medical or employment reasons, or to validate the effects of medications on a user's ability to safely operate a vehicle. For example, scoring via the DTAS can provides measurements of attention, memory, judgment, and reaction speed, both instantaneously and over time. As the aforementioned measurements, are measurements of cognition, a DTAS score could be used to evaluate the user's cognitive ability. For example, score data can be cross referenced with cognitive challenges (e.g. autism, ADHD) or medications taken (e.g. antidepressants, opioids) such that to an objective validation of the effects on cognition in general and on that required for a cognitively complex task such as driving can be made.

In certain embodiments, the systems and methods disclosed herein can be an accident reduction system for novice and experienced drivers, whereby these aforementioned drivers are repeatedly exposed to salient items while driving a vehicle virtually. In certain embodiments, a user may be required to search for, identify, and assess the potential risk of salient items. In certain embodiments, a user may be asked to search for salient items at the same speed that would be required if they were driving a vehicle. In certain embodiments, the systems and methods disclosed herein can use 2D or 3D videos of previously driven tours (taken by videographers while in a vehicle) to create a high fidelity simulation and high face validity measurement. In certain embodiments, systems and methods disclosed herein can allow novice and experienced drivers to see firsthand how native local drivers behave in geographic areas unfamiliar to them. In certain embodiments, a rules-based drive training system is disclosed that is optimized to address the unique learning needs of individuals, such as, but not limited to, those with cognitive challenges such as TBI, autism, ADHD, and age related cognitive decline. In certain embodiments, a search and awareness methodology is disclosed for improving driving ability by asking a user to repetitively search for and find salient items when driving a vehicle.

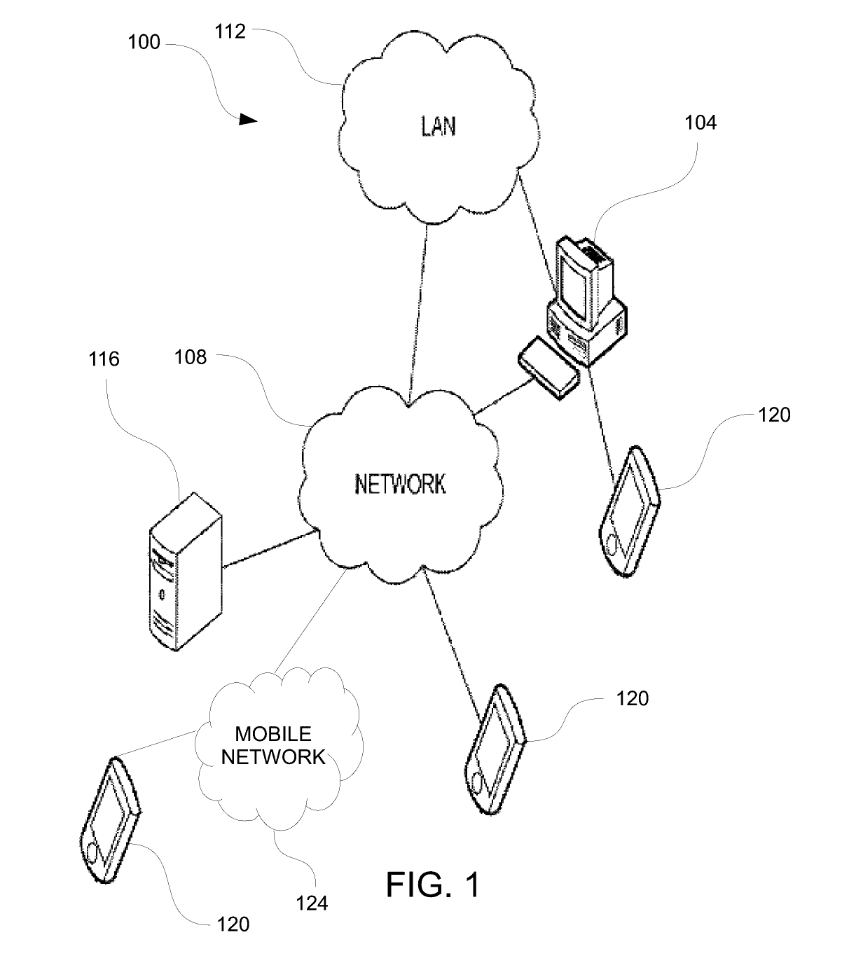

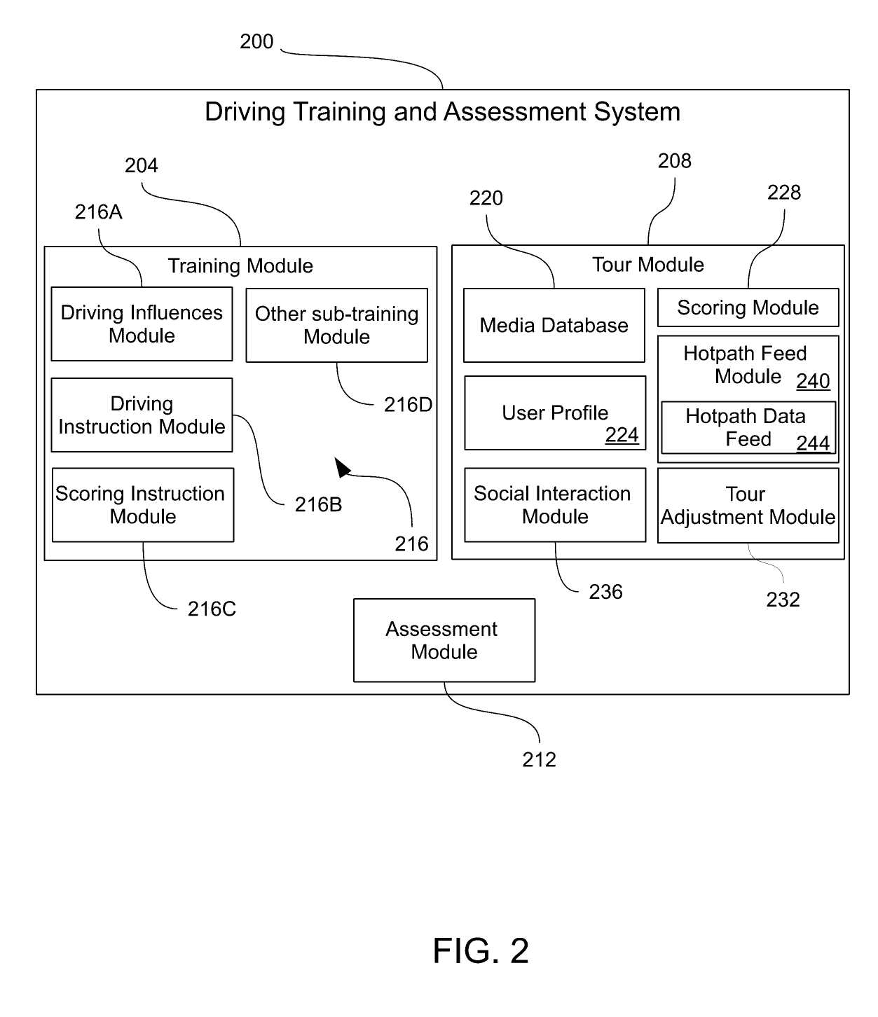

Turning now to the figures, FIG. 1 schematically illustrates an embodiment of a system 100 used facilitate that operation of a DTAS 200 (depicted in FIG. 2 and discussed below). System 100 may be used to communicate a wide variety of information within and external to DTAS 200 including, but not limited to, user information, user preferences, media files, social media connections, and driving analyses.

System 100 may include a computing device 104, an information network 108, (such as the Internet), a local area network 112, a content source 116, one or more mobile devices 120, and a mobile network 124.

Computing device 104 and mobile devices 120 may communicate through information network 108 (and/or local area network 112 or mobile network 124) in order to access information in content source 116.

As those skilled in the art will appreciate, computing device 104 may take a variety of forms, including, but not limited to, a web appliance, a mobile phone, a laptop computer, a desktop computer, a computer workstation, a terminal computer, web-enabled televisions, media players, and other computing devices capable of communication with information network 108.

Information network 108 may be used in connection with system 100 to enable communication between the various elements of the system. For example, as indicated in FIG. 1, information network 108 may be used by computing device 104 to facilitate communication between content source 116 and the computing device, as well as mobile devices 120. Those skilled in the art will appreciate that computing device 104 may access information network 108 using any of a number of possible technologies including a cellular network, WiFi, wired internet access, combinations thereof, as well as others not recited, and for any of a number of purposes including, but not limited to, those reasons recited above.

Content source 116 can be, for example, a non-transitory machine readable storage medium, a database, whether publicly accessible, privately accessible, or accessible through some other arrangement such as subscription, that holds permit related information, data, programs, algorithms, or computer code, thereby accessible by computing device 104, mobile devices 120, and DTAS 200. In an exemplary embodiment, content source 116 can include, be updated, or be modified to include new or additional driving information, such as additional media files (e.g., driving tours), additional salient items, additional driving conditions, and the like.

Mobile device 120 is generally a highly portable computing device suitable for user to interact with a DTAS, such as DTAS 200. Typically, mobile device 120 includes, among other things, a touch-sensitive display, an input device, a speaker, a microphone, and a transceiver. The touch-sensitive display is sometimes called a “touch screen” for convenience, and may also be known as or called a touch-sensitive display system. The touch screen can be used to display information or to provide interface objects (e.g., virtual (also called “soft”) control keys, such as buttons or keyboards), thereby providing an input interface and an output interface between mobile device 120 and a user of DTAS 200. Information displayed by the touch screen can include graphics, maps, text, icons, video, and any combination thereof (collectively termed “graphics”). In an embodiment, and in use with DTAS 200, a user can select one or more interface objects using the touch screen to have DTAS 200 provide a desired response.

The touch screen typically has a touch-sensitive surface, which uses a sensor or set of sensors to accept input from the user based on haptic and/or tactile contact. The touch screen may use LCD (liquid crystal display) technology, or LPD (light emitting polymer display) technology, or other display technologies. The touch screen can detect or infer contact (and any movement or breaking of the contact) on the touch screen and converts the detected contact into interaction with interface objects (e.g., one or more soft keys, icons, web pages or images) that are displayed on the touch screen. The touch screen may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen. In an exemplary embodiment of the use of mobile device 120, a user presses a finger to touch screen so as to initiate contact. In alternative embodiments, a user may make contact with touch screen using any suitable object, such as, but not limited to, a stylus.

The input device facilitates navigation among, and interacts with one or more interface objects displayed in on touch screen. In an embodiment, the input device is a click wheel that can be rotated or moved such that it can be used to select one or more user-interface objects displayed on the touch screen. In an alternative embodiment, the input device can be a virtual click wheel, which may be either an opaque or semitransparent object that appears and disappears on the touch screen display in response to user's interaction with mobile device 120.

In other embodiments, the DTAS may be implemented using voice recognition and/or gesture recognition (such as eye movement recognition), thus doing away with the need for touch screen input.

The transceiver receives and sends signals from mobile device 120. In an embodiment of mobile device 120, the transceiver sends and receives radio frequency signals through one or more communications networks, such as network 108 (FIG. 1), and/or other computing devices, such as computing device 104. The transceiver may be combined with well-known circuitry for performing these functions, including, but not limited to, an antenna system, one or more amplifiers, a tuner, one or more oscillators, a digital signal processor, a CODEC chipset, a subscriber identity module (SIM) card, and a memory. As mentioned above, the transceiver may communicate with one or more networks, such as the Internet, also referred to as the World Wide Web (WWW), an intranet and/or a wireless network, such as a cellular telephone network, a wireless local area network (LAN), and/or a metropolitan area network (MAN), and other devices. Mobile device 120 may use any of a plurality of communications standards to communicate to networks or other devices with the transceiver. Communications standards, protocols and technologies for communicating include, but are not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS), and/or Short Message Service (SMS)), or any other suitable communication protocol.

The transceiver may also be configured to assist mobile device 120 in determining its current location. For example, a geolocation module can direct the transceiver to provide signals that are suitable for determining the location of mobile device 120, as discussed in detail above. Mobile device 120 can also request input from the user as to whether or not it has identified the correct location. The user can then indicate, using the touch-screen or other means, such as voice activation, that the geolocation module has identified the appropriate location. Mobile device 120 may also include other applications or programs such as, but not limited to, word processing applications, JAVA-enabled applications, encryption, digital rights management, voice recognition, voice replication, and a browser module. The browser module may be used to browse the Internet, including searching, linking to, receiving, and displaying web pages or portions thereof, as well as attachments and other files linked to web pages.

It should be appreciated that mobile device 120 is only one example of the mobile device that may be used with the present system and method, and that the mobile device may have more or fewer components than mentioned, may combine two or more components, or a may have a different configuration or arrangement of the components. Thus, mobile device 120 is not restricted to a smartphone or other hand-held device, and may include pad or tablet computing devices, smart books, net books, laptops, and even larger computing devices.

FIG. 2 shows an exemplary DTAS, DTAS 200. At a high level, DTAS 200 allows a user to take virtual driving tours (also referred to herein as “tours”) in which the user identifies various objects along the drive. The tours are typically actual video footage of actual drives, with each tour having a certain degree of complexity, e.g., more or fewer salient items and/or more or fewer non-salient items. In certain embodiments, the user is scored throughout the tour and at the end of the tour may be given an assessment for how well the user performed on the tour. As shown in FIG. 2, DTAS 200 includes a training module 204, a tour module 208, and an assessment module 212.

At a high level, training module 204 offers information to the user regarding how to operate and navigate tour module 208. Training module 204 can include a number of sub-modules 216 that offer assistance to the user as to how DTAS 200 works or can be adjusted to meet the user's needs. For example, and as shown in FIG. 2, training module 204 can include, but is not limited to, a driving influences module 216A, a driving instruction module 216B, a scoring instruction module 216C, and other sub-training modules 216D.

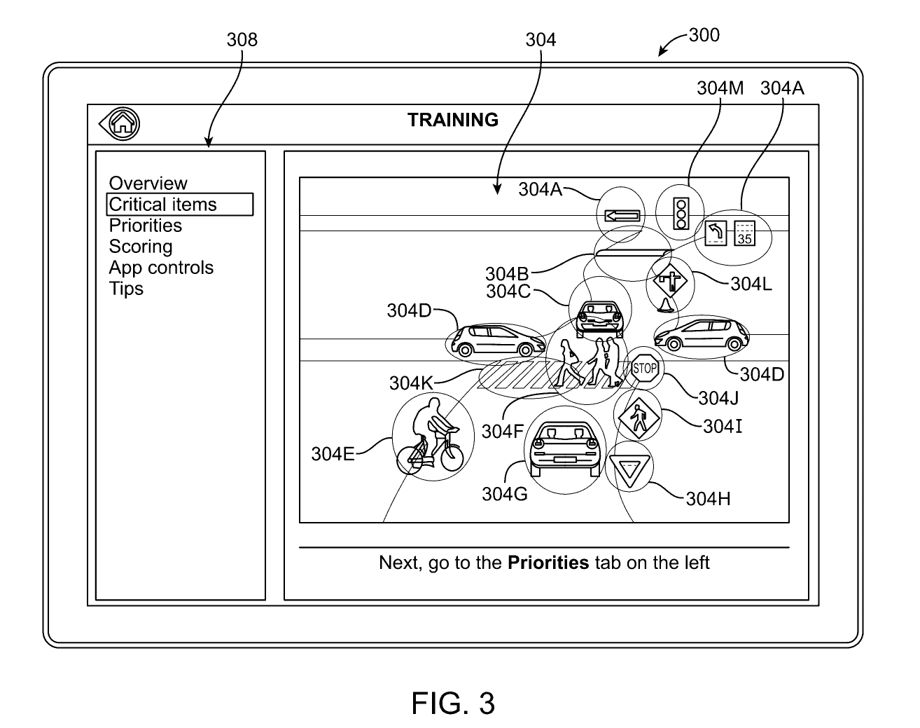

Driving influences module 216A provides guidance as to the types of salient items that the user may encounter on a tour and the recognition preference, i.e., the preferred order in which salient items should be identified when presented at similar times or simultaneously. An exemplary embodiment of a training interface 300 is shown in FIG. 3. In training interface 300, driving influence module 216A has provided salient items 304, e.g., salient items 304A-N, for the user to identify during a tour. In FIG. 3, the user is instructed to look for a regulatory signs 304A, an object in the roadway 304B, a vehicle turn signal 304C, other vehicles entering path of driver 304D, a bicyclist 304E, a pedestrian 304F, a vehicle brake light 304G, a yield sign 304H, a warning sign 304I, a stop sign 304I, a crosswalk or other pavement marking 304K, a construction sign 304L, and a traffic light 304M. Training interface 300 also provides a training menu 308, which allows the user to navigate the other portions of training module 204. As shown training menu 308 includes an option for the user to select “Priorities” which would give the user information about the recognition preference discussed above. It should be noted that the recognition preference does not override the given hotpath data feed 240 associated with the tour, but it does indicate to the user the expectations and rubric used in the development of the hotpath feed. In other words, the brake lights on a car immediately in front of the user's car will have a higher recognition preference than a pedestrian crossing further up the road. As another example, a pedestrian and/or a bicyclist will take priority over other salient items when they are directly in front of the vehicle.

Returning to FIG. 2, driving instruction module 216B provides an interface for the user to be guided through the various tour experiences. For example, a user may be taken on a brief tour and while on the tour, the user may be exposed to a salient item, such as a stop sign. Driving instruction module 216B can highlight the stop sign (using a circle around the object for example) and then given the user instruction as to what is to be done when the user sees the stop sign. In this way, the driving instruction module 216B gives the user indications as to how to use DTAS 200.

Scoring instruction module 216C provides the user with information regarding how the user will be scored while taking a tour. Scoring instruction module 216C can include examples, hypotheticals, or tables that indicate how the user will be scored. Scoring module 216C may also provide information related to the importance of identifying the salient objects in the proper order versus selecting them as quickly as possible.

Tour module 208 generally provides the primary driving lessons and scoring of a user's interactions with DTAS 200. In an exemplary embodiment, tour module 208 includes a media database 220, a user profile 224, a scoring module 228, a tour adjustment module 232, a social interaction module 236, and a hotpath feed module 240. Media database 220 typically includes video of drives (a.k.a. tours) from multiple and various locations. The drives stored in media database 220 can have a generic quality, e.g., drives without specific indications as to any particular place, or can be more fanciful—taking the user to far-off destinations, such as, but not limited to, scenic Highway 1 in California, the south-western coast of Ireland, and the Champs-Elysées in Paris. In an exemplary embodiment, each video in media database 220 includes a hotpath feed 240, which, as discussed in more detail below, can allow a user, among other things, to interact directly with the video for the identification of salient items and for dynamic scoring of the user's performance that takes into account the response time to select a salient item and the order in which the salient item(s) were selected.

The tours found in media database 200, include films of actual drives to create a more realistic experience and therefore have high fidelity and face validity. In general, tours can be assembled into collections of a plurality of drives, generally between 6 and 8 per location that include increasingly more complex stimuli. Tours can be grouped/defined by geographic area and/or skill level and/or cognitive abilities required. For example, a user can choose a tour and the first few training drives in the tour may be filmed in low-traffic, low-stimulus areas (referred to herein as “low drives”). Once the user has demonstrated sufficient mastery by obtaining passing scores in low drives, the user can progress to more complex tour that can include higher traffic or additional stimuli or both.

In a specific example, the user can be an experienced driver from Vermont, but may need training on driving in a foreign country, such as Italy. After selecting the tours of Italy, the user experiences a few drives in Italy that are low-traffic and low-stimuli. As the user demonstrates mastery by obtaining passing scores in low drives, the user progresses to more complex and chaotic drives while also observing native driving behaviors. In addition to “Italy-specific” training, at any time while watching the drive, the user can tap on unfamiliar road signs or unrecognized traffic controls to receive more information thereby learning more about how to drive in the country.

In another example, the user may be a combat veteran that has just returned from being in active combat. This user might receive training on how to avoid putting themselves in situations that would trigger an emotional response. The tours found in media database 220 may contain increasing levels of anxiety-provoking triggers. As the user demonstrates mastery by obtaining passing scores in “low trigger” drives, they are allowed to progress to drives containing more anxiety-provoking events. In this way, a combat veteran would be better prepared to drive when confronted with various anxiety-provoking events.

User profile 224 is typically a database of information that includes data related to the user, such as, but not limited to, user specific information, e.g., name, age, driving tours completed, scores, etc. The information kept in user profile 224 can be used by assessment module 212 (discussed below) to provide, for example, useful information to the user or others regarding his/her driving training progress.

Scoring module 228 generally facilitates the tracking of a user's score as the user drives on a tour. Scoring module 228 can give the user a score based on a number of factors, including, but not limited to, whether the user recognizes a given salient item, how long in absolute terms it took the user to recognize the salient item, how long it took the user to recognize the salient item relative to the overall time the item was visible, and whether the user selected salient items in the correct order of priority when multiple items were present. If, after a tour, the user believes that the tour was too fast, the user can reduce the speed of the tour so as to allow the user to have more time to recognize and select salient items. In an exemplary embodiment, scoring module 228 determines a score based, at least in part, upon the user's interaction with hotpath feed 240.

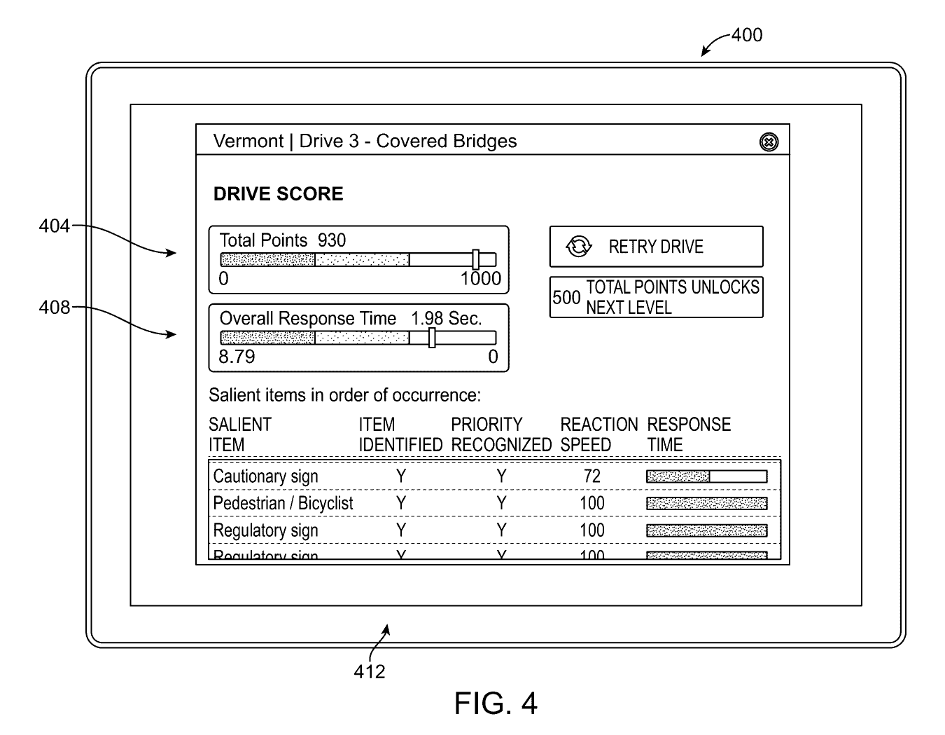

An exemplary embodiment of a scoring user interface 400 that displays information from scoring module 228 is shown in FIG. 4. Scoring user interface 400 can include information such as, but not limited to, a score 404, a response time 408, and a salient item recognition table 412. As noted above, score 404 can be determined based upon the user's identification of the salient items presented during the tour (both accuracy and response time). Response time 408, in this embodiment, is an indication of the average response time that a user took to identify a salient item presented on the tour from when the salient item was first available for identification. Salient item recognition table 412 can provide information related to the user's specific interactions with specific salient items. For example and as shown in FIG. 4, the user identified the cautionary sign in the right sequence of salient items (i.e., priority recognized column), and the user's response time was scored as slower than the best possible response time (e.g., the user scored 72 out of 100).

Tour adjustment module 232 can allow the user to adjust the difficulty level of the tour. For example, the user may adjust the speed of the drive to a relatively slower speed so that the salient items are available for identification for a longer period of time, thus making the tour less difficult. In certain embodiments, the level of difficulty may be a factor used by the scoring module.

Results, scores, and the completion of various tours can be transmitted by the user to others using social interaction module 236. Social interaction module 236 may also have interactions with the assessment module so that the user can convey the user's assessment to others.

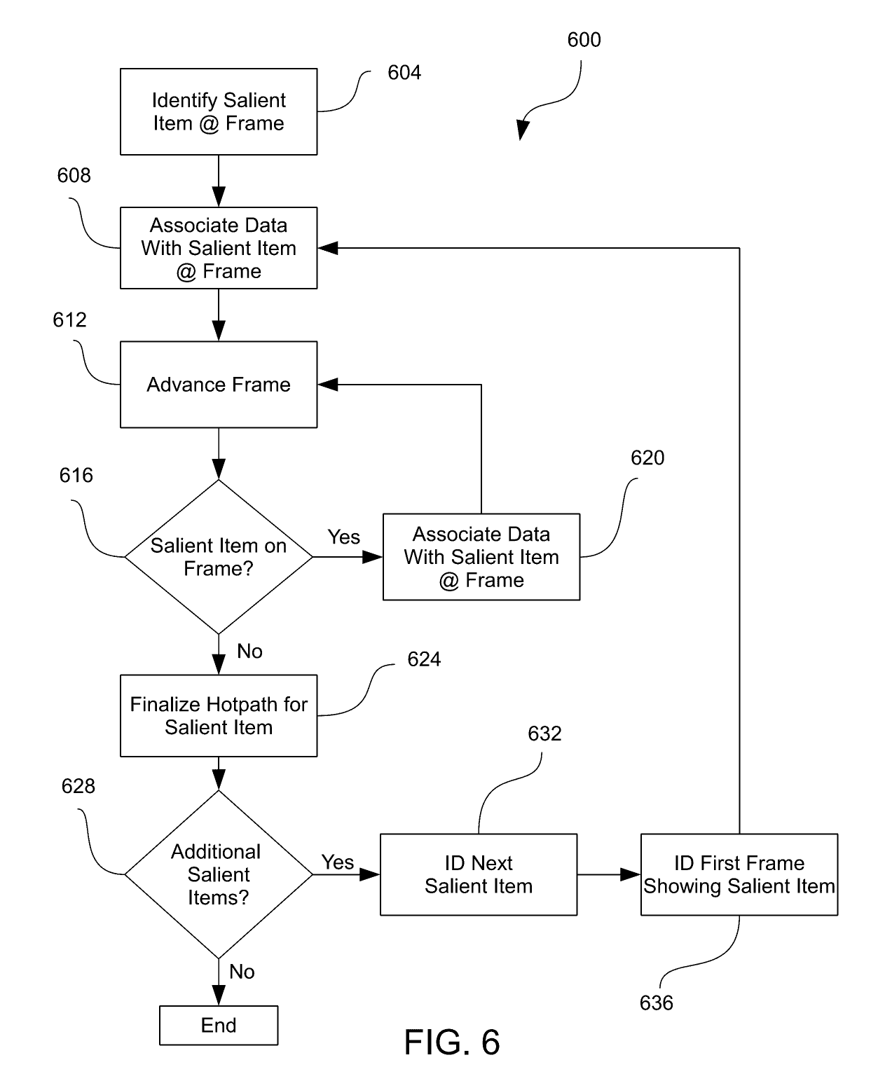

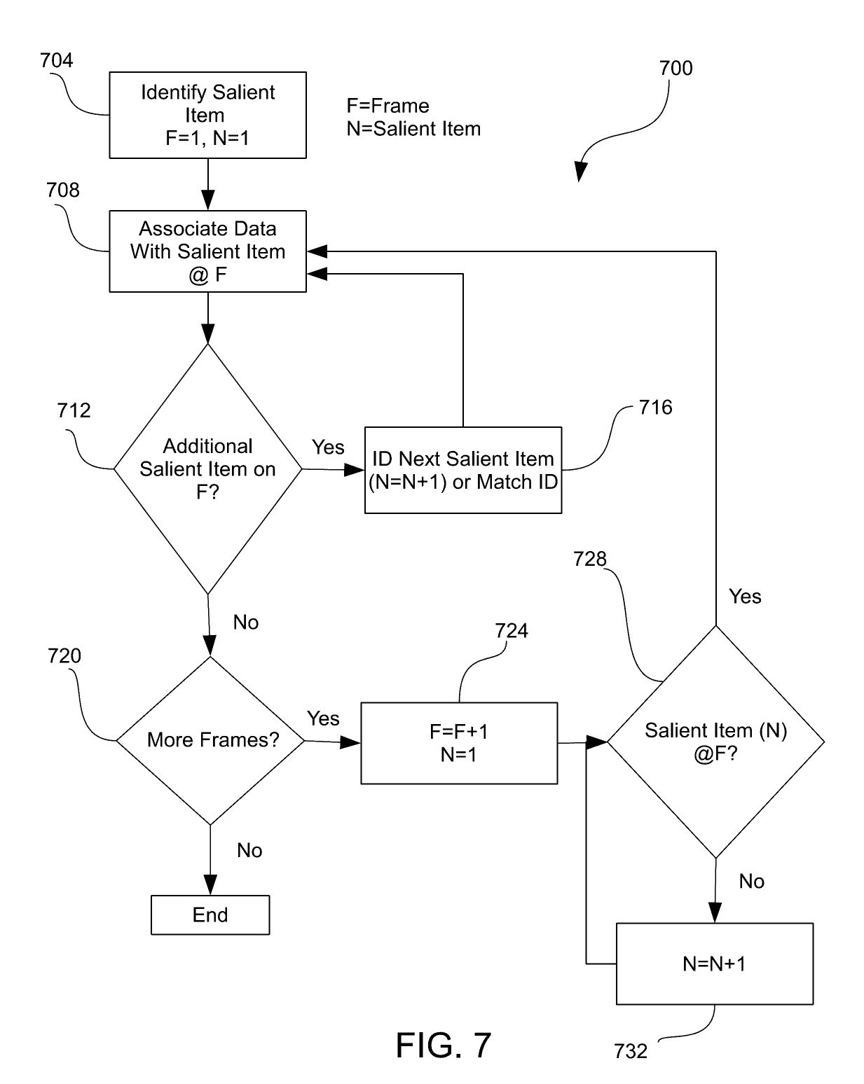

Hotpath feed module 240 develops a hotpath data feed 244 that is associated with each video file stored in media database 220. At a high level, hotpath data feed 244 is a collection of data about a salient item, including, but not limited to, the type of item, when it appears in the video, how long it appears in the video, what importance it has in the video relative to other salient items shown at the same time, etc. Detailed exemplary processes for developing a hotpath data feed 244 are discussed in FIGS. 6 and 7 below.

Assessment module 212 provides feedback to the user after the completion or termination of a tour. In an exemplary embodiment, assessment module 212 provides feedback, assessment, and analysis of the user's driving ability and where the user needs to improve. Assessment module 212 may also provide indication of what the user should try or do to challenge the user's driving abilities. For example, the assessment module 212 can suggest that the user increase the speed of the drive, thereby requiring faster reaction to salient items. Assessment module 212 may also aggregate a user's recognition errors and then provide a prediction of the user's chances of being involved in a crash if they were actually driving a vehicle. In certain embodiments, this information may be shared with a user's insurance company to allow the insurance company to more accurately assess automobile insurance fees for the user.

In certain embodiments of DTAS 200, the user's experience on a tour can be tailored to the skill level and cognitive abilities of the user. For example, the difficulty of the driving training can be impacted by the amount and type of training given as well as the amount, type, and complexity of items that the user selects. For example, training for novice drivers can incorporate rules of the road, whereas training for experienced drivers can incorporate tips for safely negotiating complex traffic, and, as mentioned above, training for combat veterans can incorporate “triggers” such as loud jets, people watching from bridges overhead, etc.

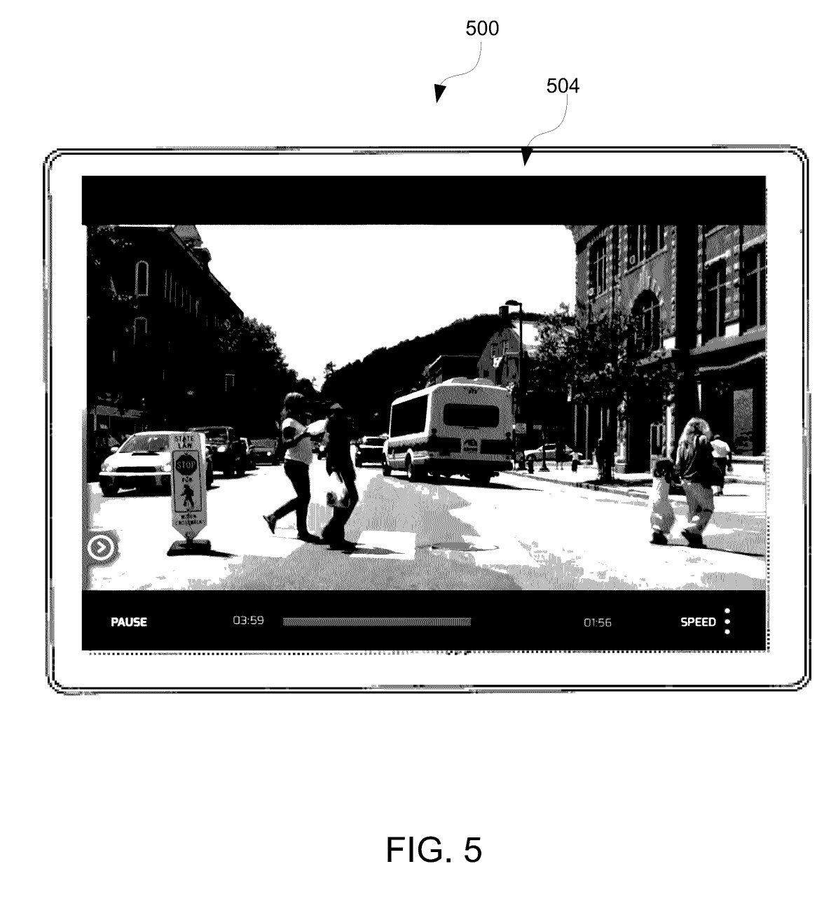

FIG. 5 is an exemplary embodiment of a screen shot 500 of a DTAS 200 in use. As shown, a mobile device, such as mobile device 120, displays a media file 504, which, in this instance, is a video file of a downtown scene. As shown, the video has a number of the previously mentioned salient items, including, but not limited to, pedestrians, vehicles, a crosswalk, a traffic signal, etc.

Turning now to FIG. 6, there is shown an exemplary process 600 for generating a hotpath data feed 244 (also referred to herein as a “hotpath file”). As discussed above, at a high level a hotpath file facilitates the assessment and cognitive learning of an individual using DTAS 200 by defining the priority by which a user should identify salient items while viewing and by providing a methodology for assessing the user's interactions with the system, e.g., the pace and accuracy of identifying items. The data associated with the hotpath data feed also forms the basis for the evaluation of the user's proficiency at the chosen tour. Hotpath data feed 244 is synched or matched to the video/media file being presented to the user in such a way that when the user interacts with (e.g., touches, points to, verbalizes) an item in the video, the user is able to experience feedback, such as an assessment of the user's identification or mis-identification of the salient item that is part of the hotpath or a display of information about the salient item, in the form of text, video insert, drawing, picture, etc. Hotpath data that is included with the hotpath data feed 244 may include, but is not limited to: type of salient object a priority of that salient object at a time t, a location of that object on the display at t, a size of the object at t, and any other information that allows the salient item to be identified and followed when it appears in the video file.

At a high level, and as shown in FIG. 6, process 600 develops a hotpath file by identifying and following a salient item at step 604 and following that salient item through successive frames of a video of the tour. This item identification and following can be performed by using image recognition techniques and software algorithms or by other methods. Typically, starting with the first frame of the media file of the tour, a salient item is identified. At step 608 data is associated with the salient item such as, but not limited to, a reference number, the type of salient item, the priority of the item when compared to other salient items on the frame (also referred to herein as “priority assignments”), the location of the item, a target size, a color, a time, etc.

Priority assignments may be based upon proximity to the user's virtual vehicle or may be based on importance. For example, pedestrians may take precedence over other types of salient items when within a certain proximity of the virtual vehicle. The spatial location or coordinates assigned to the salient item at a given frame are appropriate for the media environment. The time assigned to the salient item refers to the time that the salient item was first available for recognition by the user. Thus, when the item first appears, the time is 0. The target size assigned to the salient item defines the size of the area that the user can select (touch, point to, etc.) and be recognized as having selected the salient item. The target size also defines the size of a pop up visual that may appear in the video to acknowledge the user's successful selection of the salient item. The color of assigned to the salient item encodes the priority of the item, for example a red salient element is the highest priority and should be selected first and a yellow salient item is a secondary priority and should be selected after the priority item. Different colored popups may also appear in the video.

After data has been assigned to the salient item at the given frame (step 608), the video is advanced a frame (step 612). At step 616, it is determined whether the salient item (identified at step 604 or later at step 632) is found in the advanced frame. If it is, process 600 proceeds to step 620 where data is again assigned to the salient item, which may be different from or the same as the data assigned in the previous frame. Changes to the data may include a different priority (due to the existence of additional or evolving other salient items on the frame), a different location, a different time, etc. After assigning data at step 620, the process proceeds back to step 612 where the video frame is advanced. This process follows the salient item until it no longer appears in a frame, and at which time the process proceeds to step 624 where the hotpath for that particular salient item is complete and finalized.

Process 600 then continues to step 628, which determines whether another salient item exists, and if so, the process proceeds to step 632 where the salient item is identified and the proceeds to step 636 where the first frame showing this newly identified salient item is determined. This typically, although not necessarily, involves returning to a previous video frame where the newly identified salient item first appeared. For example, if there were two salient items on frame 1 of the media file, the process would follow the first salient item until it no longer appeared, then would return to frame 1 to follow the second salient item until it no longer appeared. If, for example, a third salient item appeared at frame 10, after the second salient item's hotpath had been developed, the process would return to frame 10 to follow the third salient item until it no longer appeared, thereby developing a hotpath for the item.

Once all salient items have been followed, the hotpaths for each salient item are merged together in time series to create the hotpath file and the hotpath file is matched in time to the media file when a user begins a tour. The resultant hotpath file, when paired with the video, results in a methodology to assess the user's proficiency at recognizing salient items. For example, scoring of the user may be determined by evaluating whether the user identified the salient items in the proper order (based on priority) and how long it took the user to identify the items.

Another exemplary process for developing a hotpath, process 700, is shown in FIG. 7. At a high level, and in contrast to process 600, process 700 identifies multiple salient items on a frame, assigns data to each of them, and then advances a frame and repeats the process. Thus, in process 700 there is no need to return to a prior frame to follow a salient item from its entrance to exit as there may be in process 600.

At step 704, a salient item is identified in the media file at a frame, F=1. The salient item is assigned a value N, where N=1.

At step 708, data is associated with salient item 1. The data associated with salient item 1 can be similar to data discussed above with reference to process 600.

At step 712, a determination is made as to whether there is another salient item on frame F; if so, the process proceeds to step 716 so as to identify the salient item, then to step 708 to associate data with that newly identified item. These three steps continue until no more salient items are in need of identification at which time the process proceeds to step 720.

At step 720, it is determined whether there are any more frames in the media file/video. If so, the process proceeds to step 724 where the frame is advanced, e.g., F=F+1, and N is returned to 1.

At step 728, it is determined whether the salient item N is on the new frame, F. If it is, the process returns to step 708 where data is associated with the salient item N at the new frame F. As before, the process attempts to identify each salient item on the new frame and associate data with it. It should be noted that if the next salient item, e.g., N+1, is no longer on the new frame, F, step 716 would advance to the next salient item. Additionally, if the salient item had not previously been identified, step 716 would assign it an identification number.

If at step 728, salient item N=1 is not at frame F the process proceeds to step 732 where the next salient item, e.g., N+1, is selected, and then reviewed at step 728 for its inclusion in frame F.

In yet another embodiment, a hotpath data feed could be created and used in real time while the user of DTAS 200 is in a moving vehicle (being driving by another person). In this embodiment, a computing device that includes DTAS 200 can include a camera that shows the roadway in front of the vehicle passage and DTAS 200 identifies and analyzes the existence of and recognition of salient items in real-time. In this way, the user of DTAS 200 could practice and demonstrate their driving skills in the context of a real time drive. This would have the advantage of including many other distractions or non-salient items that are present when in a moving vehicle, such as, but not limited to, noises from other passengers, wind and road noise, and the general feel of the moving vehicle.

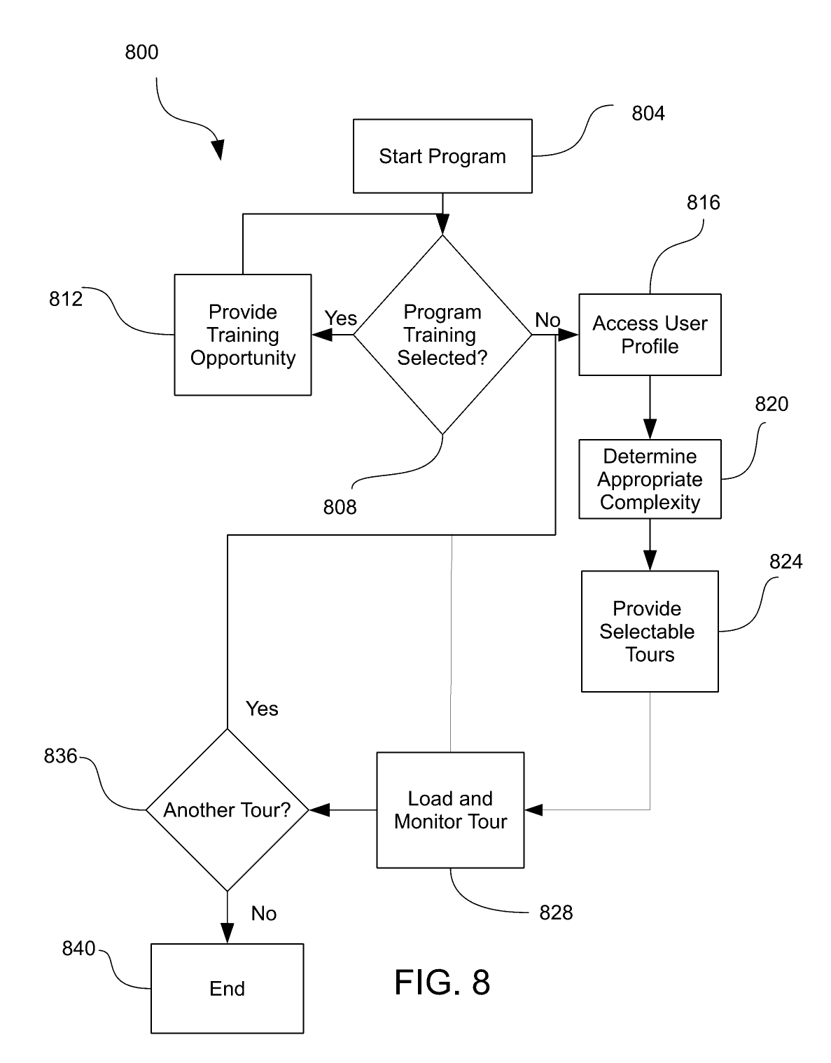

Turning now to FIG. 8, there is shown exemplary driving training processes, process 800.

At step 804, a user starts the DTAS, such as DTAS 200, which is typically embodied on a mobile device, such as mobile device 120. The user can start DTAS 200 by logging on, if the user is already registered to use the DTAS, or registering with the DTAS. Registration assists in maintaining a history of the user's use of DTAS 200 and monitoring the driving training progress of the user.

At step 808, the system determines whether the user has selected training, such as that provided by training module 204 (FIG. 2). If the training is selected, process 800 proceeds to step 812 to select a desired training area. Training areas can include, but are not limited to, instruction on salient items (driving influences module 216A), scoring (scoring instruction module 216C), interacting with the DTAS (driving instruction module 216B), etc. In an exemplary embodiment, training areas are configured for specific user needs. For example, a user returning from a military deployment can select a training area customized to allow for the user to understand how DTAS can improve their ability to drive amidst distractions. Also, in this embodiment, the training area may introduce the user to military specific distractions, e.g., loud noises, persons on building terraces or bridges, etc. After performing training, the process can return to step 808 if the user desires to engage in a tour.

If no training is selected, process 800 proceeds to step 816, where the user profile, such as user profile 224 (FIG. 2) is accessed. In an exemplary embodiment, the user profile stores information related to the user including, but not limited to, user preferences, user characteristics (e.g., military focus, young driver, elderly, disability), completed tours, completed trainings, scores, driving history, etc.

At step 820, based on the user's profile, the appropriate complexity for the user is determined. The appropriate complexity for the user can be based, among other things, on the user's driving history, completed trainings, and completed tours.

At step 824, the user is presented with a number of tours, which may be limited by the complexity determined at step 820. In an exemplary embodiment, tours are classified into three groups: low complexity, medium complexity, and high complexity. Of course, more or different classifications may be used. As noted above with respect to tour module 208 (FIG. 2), tours can range from the mundane to far flung adventures and may vary in difficulty and/or competence. In an exemplary embodiment, a user is required to obtain a certain score in a certain number of base level tours (tours with low level of difficulty, e.g., a limited number of salient items and at a relatively low driving speed) before the user can access more challenging tours. In another exemplary embodiment, the user is presented with a continuum of less-complex to more-complex drives. In another exemplar embodiment, the user is presented with the option of selection foreign tours, e.g., a “Tours of Italy”, a “Tours of Vancouver”, a “Tours of San Francisco”, etc., where the user can watch local area drives to understand how the roads are laid out and get familiar with the driving behaviors of the local population.

At step 828, the selected tour is loaded. The process for loading and monitoring a user's interaction with the tour can be carried out, for example, using process 900, described in more detail below. Data collected during the loaded tour at step 828 can be stored in the user profile 224 (FIG. 2). At the completion of the tour or when a user desires to exit the tour, the process proceeds to step 836 where the user can take another tour by returning to step 816. In an example, after the successful completion of a tour by a user and the update of the user's profile to reflect this success, the type of tours available to the user at step 824 may change.

If no further driving is desired by the user, the process proceeds to step 840 where process 800 ends.

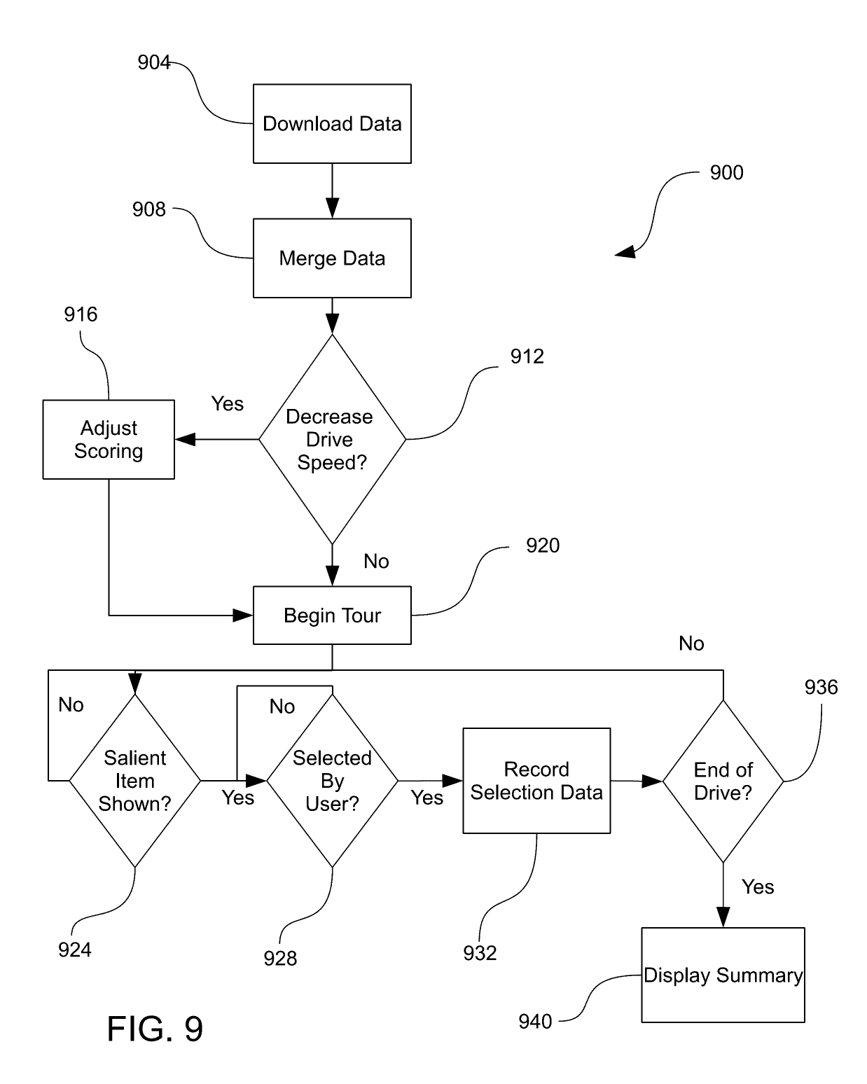

Turning now to FIG. 9 and a discussion of the loading and monitoring of a user's interaction with a DTAS and specifically, with a user's interaction while engaged with a tour, there is shown an exemplary process 900.

At step 904 data is downloaded from respective databases. In an exemplary embodiment, the data includes a media file (typically in the form of a video) and a hotpath data feed (such as hotpath data feed 244). In an exemplary embodiment, the hotpath data feed is a dataset that includes the sequential coordinates (x, y; Cartesian, spherical, etc.) and video frame location of each individual salient item found in linked media file. For each salient item, the hotpath data feed also includes the type of salient item and the duration of the time that the salient item is visible on the device during the tour. In an exemplary embodiment, the hotpath data feed is developed via process 600, described above. In another exemplary embodiment, process 700 is used to develop a hotpath data feed. In any event, a hotpath data feed typically includes the all of the individual hotpaths in the respective video. In another exemplary embodiment, in addition to the video file and hotpath data feed there is included a language file that allows for translations when the tour is in the user's non-native country. Inclusion of the language file can, for example, be used when the user sees a sign the user does not recognize (e.g. “chemin a la sortie sud d'astrub”). In that instance, the user can select the sign and have provided to them an explanation in the user's native language of what the signs means and what the user should do when they see that sign.

At step 908, all data is merged together. In an exemplary embodiment, the frame number used to develop the hotpath data feed is matched with the frame number of the media file such that the two are synchronized.

At step 912, it is determined whether the speed of the drive is or should be reduced. The reduction of speed can be based upon the user's profile, a specific request, or may be predetermined based upon the user's prior experience with the DTAS. For example, a user with little experience may have the speed of the tour reduced so as to be able to more readily navigate and select the salient items that will appear in the video. In another embodiment, a user with significant experience may nonetheless chose to slow the speed of the tour of a foreign country so as to have more time to assimilate.

If the drive is slowed below the “normal” speed, process 900 proceeds to step 916 where the scoring of the user's activities (e.g., selecting salient items) while taking the tour is adjusted to reflect the slower rate. In an exemplary embodiment, the scoring is proportional to the reduction in speed, e.g., a 60% reduction in speed results in a corresponding 60% reduction in scoring.

At step 920, the tour is begun. In an exemplary embodiment, the user is shown a video of a previously filmed drive and is asked to select items in the appropriate sequence. Typically, a user selects stimuli or items that might have the potential to cause a crash if the user did not notice and/or attend to these items. As the user watches the drive, the user selects certain predetermined items (e.g., the salient items), by tapping, touching, pointing to them, voicing their appearance, etc. More specifically, and as represented in process 900, at step 924, there is a determination as to whether a salient item that has not been selected is shown in the video. If not, this process step cycles until there is a salient item available for selection. If a salient item has appeared, the process continues to step 928 where a determination is made as to whether the salient item has been selected by the user. As mentioned previously, the hotpath data feed includes information regarding the time origination of the salient item on the video screen as well as the priority of the item in relation to other salient items.

Once the user selects the salient item, the process proceeds to step 932 where the data is then recorded. This data can include, but is not limited to, the total time the salient item was available before selected, whether it was selected, whether it was selected appropriately when compared to other salient items available to the user for selection, a score, etc. In an exemplary embodiment, the item which the user selects is compared to the coordinate and video frame locations contained in a video hotpath data feed. If there is a match, the user is considered to have seen and recognized that item. In an exemplary embodiment, the user is also evaluated as to whether he chose the items in the correct order. For example, selecting the brake lights on the vehicle immediately in front of the user's automobile takes priority over other items such as a green light way out in front, thus selection of the brake lights first would result in a higher score. As another example, pedestrians and bicyclists in the street can take priority over other items (such as a speed limit sign or green light) and their identification results in a higher score. As another example, when stopped at a red light, the red light has priority over any items that may be occurring beyond the red light and selection of the red light results in a higher score. As yet another example, emergency vehicles take priority over other items and their selection results in a higher score. Typically, a user could determine the relevant rules applicable to scoring in the training module (as discussed above). Additionally, in this embodiment, if the user selects an incorrect (non-salient) item, they are audibly or visually informed with an “error” tone or “error” visual. Likewise, the user will be alerted with a distinctive tone if they select the same object multiple times.

At step 936, it is determined whether all salient items have been selected and the tour is completed. If not, the process returns to step 924. If the tour is complete, the process continues to step 940 where a summary is provided based upon the information recorded at step 932. The summary can include an overall score (aggregating the user's activities) and can include details on how the user addressed each salient item. The summary may be used for training or assessment purposes.

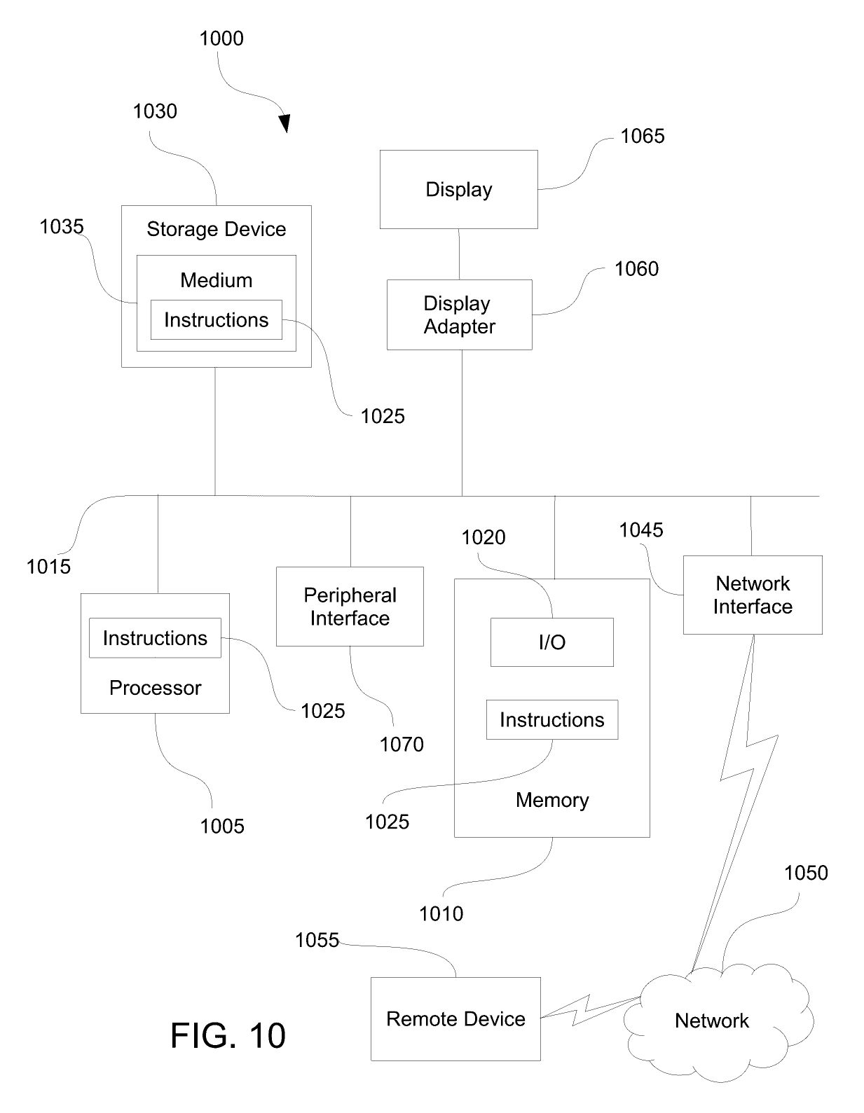

FIG. 10 shows a diagrammatic representation of one embodiment of computing system in the exemplary form of a system 1000, e.g., computing device 104, within which a set of instructions that cause a processor 1005 to perform any one or more of the aspects and/or methodologies, such as methods 600, 700, 800, and 900, of the present disclosure. It is also contemplated that multiple computing devices, such as computing device 104, mobile device 120, or combinations of computing devices and mobile devices, may be utilized to implement a specially configured set of instructions for causing DTAS 200 to perform any one or more of the aspects and/or methodologies of the present disclosure.

System 1000 includes a processor 1005 and a memory 1010 that communicate with each other via a bus 1015. Bus 1015 may include any of several types of communication structures including, but not limited to, a memory bus, a memory controller, a peripheral bus, a local bus, and any combinations thereof, using any of a variety of architectures. Memory 1010 may include various components (e.g., machine-readable media) including, but not limited to, a random access memory component (e.g., a static RAM “SRAM” or a dynamic RAM “DRAM”), a read-only component, and any combinations thereof. In one example, a basic input/output system 1020 (BIOS), including basic routines that help to transfer information between elements within system 1000, such as during start-up, may be stored in memory 1010. Memory 1010 may also include (e.g., stored on one or more machine-readable media) instructions (e.g., software) 1025 embodying any one or more of the aspects and/or methodologies of the present disclosure. In another example, memory 1010 may further include any number of program modules including, but not limited to, an operating system, one or more application programs, other program modules, program data, and any combinations thereof.

System 1000 may also include a storage device 1030. Examples of a storage device (e.g., storage device 1030) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD or a DVD), a solid-state memory device, and any combinations thereof. Storage device 1030 may be connected to bus 1015 by an appropriate interface (not shown). Example interfaces include, but are not limited to, SCSI, advanced technology attachment (ATA), serial ATA, universal serial bus (USB), IEEE 10395 (FIREWIRE), and any combinations thereof. In one example, storage device 1030 may be removably interfaced with system 1000 (e.g., via an external port connector (not shown)). Particularly, storage device 1030 and an associated non-transitory machine-readable medium 1035 may provide nonvolatile and/or volatile storage of machine-readable instructions, data structures, program modules, and/or other data for system 1000. In one example, instructions 1025 may reside, completely or partially, within non-transitory machine-readable medium 1035. In another example, instructions 1025 may reside, completely or partially, within processor 1005.

System 1000 may also include a connection to one or more systems or software modules included with system 100. Any system or device may be interfaced to bus 1015 via any of a variety of interfaces (not shown), including, but not limited to, a serial interface, a parallel interface, a game port, a USB interface, a FIREWIRE interface, a direct connection to bus 1015, and any combinations thereof. Alternatively, in one example, a user of system 1000 may enter commands and/or other information into system 1000 via an input device (not shown). Examples of an input device include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touch screen (as discussed above), and any combinations thereof.

A user may also input commands and/or other information to system 1000 via storage device 1030 (e.g., a removable disk drive, a flash drive, etc.) and/or a network interface device 1045. A network interface device, such as network interface device 1045, may be utilized for connecting system 1000 to one or more of a variety of networks, such as network 1050, and one or more remote devices 1055 connected thereto. Examples of a network interface device include, but are not limited to, a network interface card, a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a direct connection between two computing devices, and any combinations thereof. A network, such as network 1050, may employ a wired and/or a wireless mode of communication. In general, any network topology may be used. Information (e.g., data, instructions 1025, etc.) may be communicated to and/or from system 1000 via network interface device 1055.

System 1000 may further include a video display adapter 1060 for communicating a displayable image to a display device 1065. Examples of a display device 1065 include, but are not limited to, a liquid crystal display (LCD), a cathode ray tube (CRT), a plasma display, and any combinations thereof.

In addition to display device 1065, system 1000 may include a connection to one or more other peripheral output devices including, but not limited to, an audio speaker, a printer, and any combinations thereof. Peripheral output devices may be connected to bus 1015 via a peripheral interface 1070. Examples of a peripheral interface include, but are not limited to, a serial port, a USB connection, a FIREWIRE connection, a parallel connection, a wireless connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A driving training system comprising:
a media database including a video file, the video file include a plurality of salient items;
a computing device in electronic communication with the video file, the computing device including a processor, the processor including a set of instructions for:
identifying ones of the a plurality of salient items;
developing a hotpath data feed for each of the ones; and
merging the hotpath data feed for each of the ones with the video file so as to create a synchronized merge file.

2. A driving training system according to claim 1, wherein the video file is a recorded video of a previously taken vehicle drive.

3. A driving training system according to claim 1, further including a display coupled to the computing device, and wherein the processor further includes the instruction of displaying the merge file on the display and allowing a user to interact with the merge file.

4. A driving training system according to claim 3, wherein the processor further includes the instruction of evaluating the allowing so as to determine a score for the user.

5. A driving training system according to claim 4, wherein the evaluating includes determining how quickly the user has selected ones of the plurality of salient items.

6. A driving training system according to claim 5, wherein the evaluating includes determining whether the user has selected ones of the plurality of salient items in a predetermined order.

7. A driving training system according to claim 4, wherein the evaluating includes determining whether the user has selected ones of the plurality of salient items in a predetermined order.

8. A driving training system according to claim 1, wherein the video file includes a plurality of non-salient distractions that are specially chosen to assist combat veterans.

9. A driving training system according to claim 8, wherein the plurality of non-salient distractions include at least one of a loud noise, a pedestrian on a bridge, and a crowd of people.

10. A driving training system according to claim 1, further including a language database and wherein the merging includes combining the video file, the hotpath data feed for each of the ones, and the language database.

11. A method of improving the ability of a user to recognize salient objects while driving a vehicle, the method comprising:
providing a driving training system that includes a merge file, the merge file including a video file and a hotpath data feed, the hotpath data feed being associated with a plurality of salient items;
receiving, from the user, information;
developing a user profile from the receiving;
displaying at least one merge file to the user based upon the user profile;
allowing the user to select one of the at least one merge file; and
evaluating the user's interactions with the selected one.

12. A method according to claim 11, wherein the video file is a recorded video of a previously taken vehicle drive.

13. A method according to claim 11, wherein the evaluating includes determining a score for the user.

14. A method according to claim 13, wherein the evaluating includes determining how quickly the user has selected ones of the plurality of salient items.

15. A method according to claim 14, wherein the evaluating includes determining whether the user has selected ones of the plurality of salient items in a predetermined order.

16. A method according to claim 13, wherein the evaluating includes determining whether the user has selected ones of the plurality of salient items in a predetermined order.

17. A method according to claim 11, wherein the video file includes a plurality of non-salient distractions that are specially chosen to assist combat veterans.

18. A method according to claim 17, wherein the plurality of non-salient distractions include at least one of a loud noise, a pedestrian on a bridge, and a crowd of people.

19. A method according to claim 11, wherein the hotpath data feed is developed by:
identifying a first salient item on a first frame of the video file;
associating a first hotpath data with the first salient item, the first hotpath data being related to the first frame;
advancing to a second frame of the video file;
locating the first salient item; and
associating a second hotpath data with the first salient item, the second hotpath data being related to the second frame.

20. A method according to claim 11, wherein the hotpath data feed is developed by:
identifying a first plurality of salient items on a first frame of the video file;
associating a first plurality of hotpath data with a corresponding respective one of the plurality of salient items, the first hotpath data being related to the first frame;
advancing to a second frame of the video file;
identifying a second plurality of salient items on the second frame of the video file;
associating a second plurality of hotpath data with a corresponding respective one the second plurality of salient items, the second hotpath data being related to the second frame.
